(19) United States
(12) Patent Application Publication
(10) Pub. No.: US 2018/0292896 A1
(43) Pub. Date: Oct. 11, 2018

(54) HEAD-MOUNTED DISPLAY DEVICE

(71) Applicant: INTEL CORPORATION, Santa Clara, CA (US)

(72) Inventors: Richmond F. Hicks, Aloha, OR (US); Daniel H. Zhang, Hillsboro, OR (US)

(73) Assignee: INTEL CORPORATION, Santa Clara, CA (US)

(21) Appl. No.: 15/480,970

(22) Filed: Apr. 6, 2017

(51) Int. Cl. G06F 3/01; G09G 5/391; G06T 5/00; G09G 3/36; G09G 3/32

(52) U.S. Cl. CPC G06F 3/013; G09G 5/391; G09G 3/32; G06F 3/012; G09G 3/36; G06T 5/002

(57) ABSTRACT

In one example, a head-mounted display (HMD) device includes a laser pattern generator to generate a pattern that is directed into an eye and reflected off of a retina and back out of the eye. A camera is included to capture an image of a reflected pattern from the retina. A pattern analyzer is included to determine a point spread function for the eye from the reflected pattern and to determine a focus plane for a user from the point spread function. A rendering engine renders the content on a display, wherein content at the focus plane is rendered at a higher resolution of the display, and content not at the focus plane is rendered at a lower resolution for the display.

### TECHNICAL FIELD

The present disclosure relates generally to head-mounted displays. More specifically, the present techniques relate to a head-mounted display that includes a system for determining a focus plane.

### BACKGROUND

Virtual reality systems provide a person with the feeling of actually being immersed in a particular computer-generated virtual environment. The typical virtual reality system includes a head-mounted display, which includes circuitry to track the user's head movements and adjust the displayed image based on the point of view indicated by the user's head movement. The virtual reality system may also include circuitry to receive user input that enable the user to manipulate objects in the virtual environment and move within the virtual movement. Such virtual reality systems have applications in video game systems, entertainment, simulation of actual environments, and others.

### BRIEF DESCRIPTION OF THE DRAWINGS

The following detailed description may be better understood by referencing the accompanying drawings, which contain specific examples of numerous features of the disclosed subject matter.

FIG. 1 is a drawing of an example of a head-mounted display device (H MD) in accordance with some embodiments.

FIGS. 2(A)-2(C) are drawings of a three dimensional scene that illustrate the relationship between the stereoscopic cues and the eye stress and discomfort that they may cause.

FIG. 3 is a horizontal cross sectional view of an example of an eye box for an HMD that can determine a focus plane in accordance with some embodiments.

FIGS. 4(A) and 4(B) are schematic diagrams illustrating an example of the determination of a focus plane for an eye, using a point spread function of a laser pattern in accordance with some embodiments.

FIG. 5 is a drawing of another example of a laser pattern for the determination of a point spread function to identify a focus plane for a viewer in accordance with some embodiments.

FIG. 6 is a process flow diagram of an example of a method for determining a focus plane of a viewer and rendering objects at the focus plane in focus in accordance with some embodiments.

FIG. 7 is a block diagram of an example of a computing system that may be used to provide a head mounted display (HMD) with content in accordance with some embodiments.

FIG. 8 is a block diagram of an example of components that may be present in an HMD in accordance with some embodiments.

FIG. 9 is a block diagram of a non-transitory, machine readable medium that may include code to direct a processor to determine a focus plane of a viewer and render objects at the focus plane in focus in accordance with some embodiments.

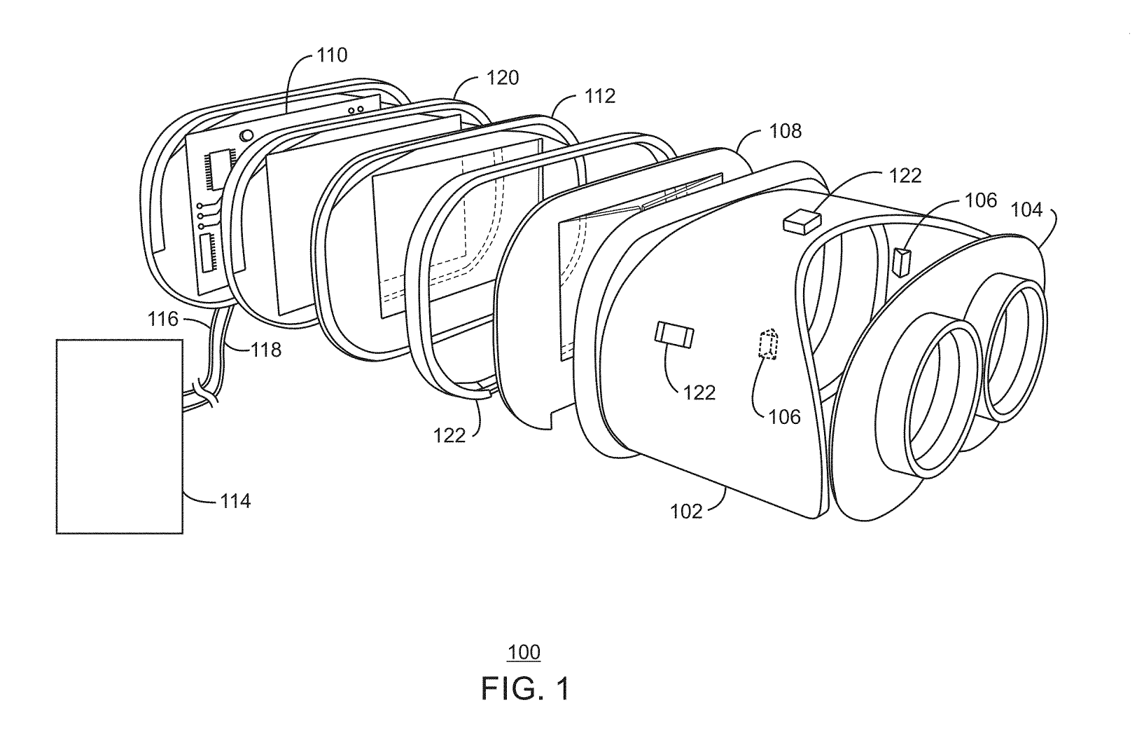

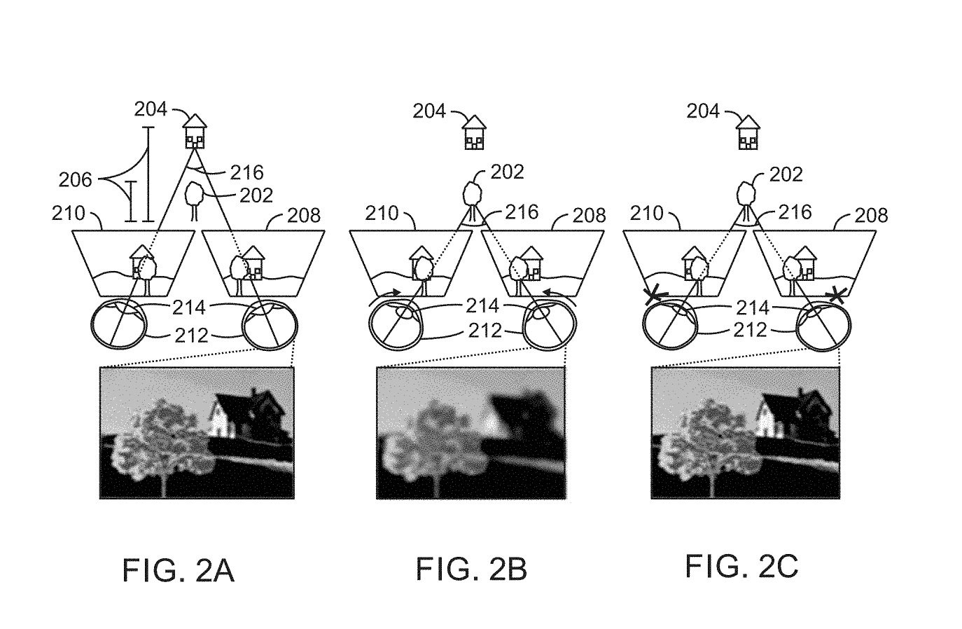

In some cases, the same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

A head-mounted display (HMD) is a device that is worn on a viewer's head to provide the viewer virtual or augmented reality experiences. These experiences may use three-dimensional (3D) images to help the viewer feel immersed in the visual experience being presented. HMD devices can display 3D images by presenting two stereoscopically shifted images, one before each eye, at the same time. Each of the images are eye-specific, for example, presenting a scene from the perspective of the specific eye, e.g., right or left, before which the image is presented. The images are combined by the viewer's visual system to provide the appearance of depth, creating an illusion of a 3D image to the viewer.

Current HMD devices present images at one focal length. However, as discussed herein, this may affect the reality of the scene. Like a camera focusing on the subject of a photograph, the eyes focus on objects in their field of view at their respective distances. These distances are referred to as their focal length or focus plane. Thus, when the eyes focus at a certain focal length, objects at that distance come into focus, and objects at other distances appear to blur, in a phenomenon called retinal blur. A scene that does not have the correct retinal blur may lose reality, and can, in some users, cause eye fatigue and nausea.

Techniques described herein allow HMD devices to present images in which all of the content in a particular focus plane is within focus. As described herein, this may be performed by measuring the focus plane of the eye by projecting a pattern into the eye, and measuring a reflection of that pattern returned from the retina in the eye. A point spread function for the pattern in the reflection may be determined, and used to determine the focus distance or focus plane for the eye. The content at that focus plane may be rendered in focus, for example, being presented at a higher resolution on a display screen.

As used herein, a higher resolution indicates a higher proportion of independent pixels for a given area, up to the full pixel resolution of the display screen, are used to display objects within that area. Lower resolution indicates that pixels may be filtered using a median or blur filter to simulate the expected retinal blur. Accordingly, content displayed at a higher resolution will appear to be in focus, while content displayed at lower resolution will appear to be blurred.

FIG. 1 is a drawing of an example of a head-mounted display device (HMD) 100 in accordance with some embodiments. In this example, the HMD 100 includes an eye box 102. The eye box 102 may include a lens array 104 to allow focusing and optical adjustments for a user. The lens array 104 may include multiple lenslets (small lenses) that are in the same plane, and parallel with respect to other optical devices in the HMD 100.

The HMD may include mirrors 108 that are partially silvered, or that reflect near infra-red (NIR) light while passing visible light. The lens array 104 directs the light from a number of sources on to a user's eyes, for example, by transmitting light from the display panel 112 to the eyes, and direct light reflected from the user's eyes, including, for example, the cornea and retina, to other structures in the lightbox 102.

The lightbox 102 may also include an eye tracking system 106 to track the user's eye orientation, such as the direction of the gaze. To avoid distractions for the user, the eye tracking system 106 may use light frequencies that are invisible to a user, such as near infrared light (NIR). The NIR wavelengths generally start at about 700 nanometers (nm), often considered the upper edge of visible light, and go to about 1200 nm. As described herein, the eye tracking system 106 includes a mechanism to determine a focus plane for an eye, allowing the determination of a focus distance for a user.

A number of other systems may be included in the HMD 100 to provide the functionality. These may include, for example, a circuit board 110 that renders video for the HMD 100 on a display panel 112. The circuit board 110 may accept input from an external system, such as a media computer 114, through a wired network cable 116. The wired network cable 116 may be used to provide power to the circuit board 110 for the HMD 100, or a power cable 118 may be coupled to the media computer 114, or to a power block, to power the HMD 100. In some examples, the circuit board 110 may include a radio transceiver to accept input from the media computer 114 without the use of a cable. Further, the HMD 100 may include a battery to power the circuit board 110.

A backlight 120 may be included to illuminate the display panel 112, for example, if the display panel is a liquid crystal display. In other examples, the display panel 112 may be an organic light emitting diode (OLED) panel, and the backlight 120 may be eliminated.

A spacer 122 may be used to provide a better focal distance to the display panel 112, for example, depending on the lens array 104. The spacer 122 may also hold a polarizing sheet, which may be used with a second polarizing sheet, mounted over the backlight 120, to form images from a liquid crystal display. The spacer 122 may be eliminated, for example, if the mirror panels 108 include a polarizing sheet, or if the display panel 112 is an OLED panel.

Other technologies may be used to form the images for display, such as laser scanning technologies, without affecting the determination of a user focus plane, as described herein. Further, any number of other units may be included to provide functionality. For example, to determine a user's head orientation and motion, the HMD 100 may include motion sensors 122, which may include micro-electromechanical system (MEMS) based accelerometers, gyroscopes, and the like. The motion sensors 122 may also interact with external devices to determine the orientation and motion, for example, including multi-axis GPS systems, external optical devices, and the like.

FIGS. 2(A)-2(C) are drawings of a three dimensional scene 200 that illustrate the relationship between the stereoscopic cues and the eye stress and discomfort that they may cause. Generally, three dimensional vision operates through autonomic eye adjustments termed accommodation and convergence.

Accommodation is the process by which an eye focuses on objects. In this process, the ciliary muscle in the eye contracts, causing the lens of the eye to assume a more spherical shape to focus on closer objects. When the ciliary muscle in the eye relaxes, the lens of the eye may assume a more discus shape to focus on farther objects. In addition to the focal length of the eye, the contraction and relaxation of the ciliary muscles also provides information about the depth to the brain.

Convergence is a process by which both eyes track objects as they move closer or farther from a viewer. When an object moves nearer to a viewer, the eyes converge, for example, inward towards the bridge of the nose, to keep both eyes pointed towards a focal point on the object. As the object moves further away, the eyes diverge, for example, outwards away from the bridge of the nose, to keep both eyes pointed towards a focal point on the object. As in accommodation, feedback from the eye muscles that initiate these convergence movements provide some information about the object's distance to the brain.

The accommodation and convergence processes act in unison when viewing objects. For example, as an object is brought closer to the eyes, each eye accommodates to the position of the object by contracting the ciliary muscle to bring the focal point closer. At the same time, the eyes converge to keep the focal point for each eye at the same place on the object. The brain is hardwired to automatically link these operations, for example, one process automatically triggers the other process.

As both the left-eye image and the right-eye image of a stereoscopic display are generated by flat 2-D display elements, such as liquid-crystal-display (LCD) panels, the optical viewing distance to each pixel of the image is the same, and all parts of the image may be in focus. However, this visual cue conflicts with the cue provided by the stereoscopic information. The visual cues provided by the stereoscopic information is that some objects are at depths different from the display elements, e.g., in front of or behind the display elements, but the visual cue provided by the uniform optical viewing distance is that all of the objects are at the same distance, which causes accommodation to focus the eye to the distance of the screen. When the viewed object is positioned at the actual distance of the display element, accommodation and convergence match, e.g., the eyes can converge and focus to matching distances, resulting in a sharp image of the object.

This is illustrated in FIG. 2(A). It can be noted that there is only one correct distance for accommodation when viewing conventional stereoscopic displays. In other words, despite the fact that the stereoscopic cue places the tree 202 and the house 204 at different stereoscopic distances 206 as shown in the right stereo image 208 and left stereo image 210, both the tree 202 and the house 204 will be in focus if the eyes' 212 accommodation, or focus, is at the correct distance. In this case, the retinal blur is incorrect with respect to the stereoscopic information regarding the distances to the tree 202 and the house 204. As shown in the stereo images of the display elements 208 and 210 of FIG. 2(A), the tree 202 in the foreground should be blurry according to the stereoscopic information provided by the convergence of the eyes 212.

As shown in FIG. 2(B), when eyes converge on a new object, such as the tree 202, the convergence causes accommodation to reflexively follow, resulting in the stereo display being uniformly blurry. This is because the objects, for example the tree 202 and the house 204, are perceived to be stereoscopically positioned behind the display elements 208 and 210. This requires that the eyes 212 point behind the display elements 208 and 210, while focusing at the distance of the display elements 208 and 210.

Thus, as shown in FIG. 2(C), in order to bring the stereo display back into focus, a viewer unnaturally decouples the linked processes of accommodation and convergence by keeping the accommodation, represented in the figure by the size of the eye lens 214, fixed at the distance of the house 202 while adjusting the convergence 216 to the distance of the tree. This may result in eye stress and discomfort, a loss of reality of the scene, or both.

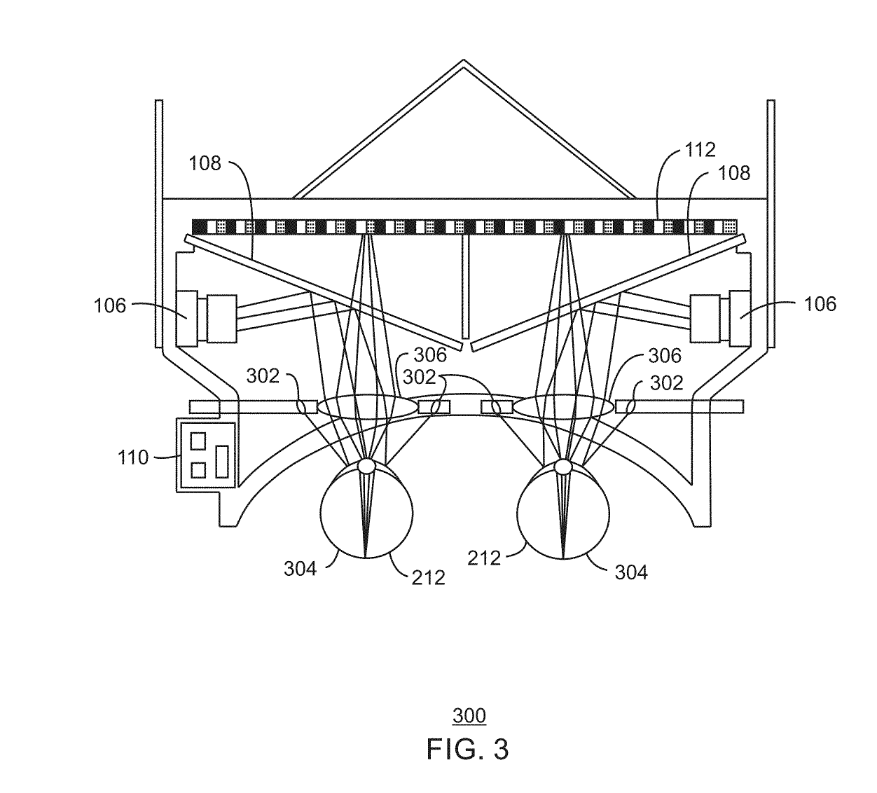

FIG. 3 is a horizontal cross sectional view of an example of an eye box 300 for an HMD that can determine a focus plane in accordance with some embodiments. Like numbered items are as described with respect to FIGS. 1 and 2. As described herein, an eye tracking system 106 may be used to track the orientation of the user's eyes 212, by reflecting light off of the eyes and determining the eye orientation based at least in part on the reflections. This may be performed, for example, by radiating an eye with light from NIR LEDs 302, and detecting the light using an image sensor, such as a CMOS image detector, or a charge coupled device (CCD), in the eye tracking system 106.

In the present techniques, the eye tracking system 106 may also include a pattern generator that may be used to determine the focus plane for the eyes based on changes in the pattern. For example, the pattern generator may be a laser source, for example, using an array of NIR light-emitting diode (LED) lasers, or an array of vertical cavity surface emitting lasers (VCSELs). The laser pattern generator may omit a pattern, such as an array of dots, that is emitted or reflected into an eye 212, off of the retina 304, and returned by a lens 306 and a mirror panel 108 to a camera in the eye tracking system 106 to determine a focus plane for the user. The mirror panel 108 may be partially silvered to allow content from sources directly in line with the user's eyes, such as the display panel 112, to pass through, while reflecting light to and from other systems, such as the eye tracking system 106. Alternatively, the mirror panel 108 may be reflective to the NIR wavelengths used by the camera 106 while being transparent to the visible wavelengths used by the display 112.

The focus plane may then be used to render objects at the focus plane in focus, and objects that are closer or farther than the focus plane out of focus, e.g., blurry. Further, the focus plane may be used to adjust the resolution of objects based, at least in part, on their proximity to that focus plane. Objects that are closer to the focus plane may be rendered in higher resolution, while objects that are farther from the focus plane may be rendered at lower resolution. Alternatively, the entire image may be rendered at high resolution and then a blur function may be applied whereby the blur is proportional to the distance of the object to the focus plane. Alternatively, the portion of the image falling in the fovea may be rendered at high resolution and then objects falling within the fovea may be blurred according to their distance to the focus distance while the remainder of the scene is rendered at lower resolution.

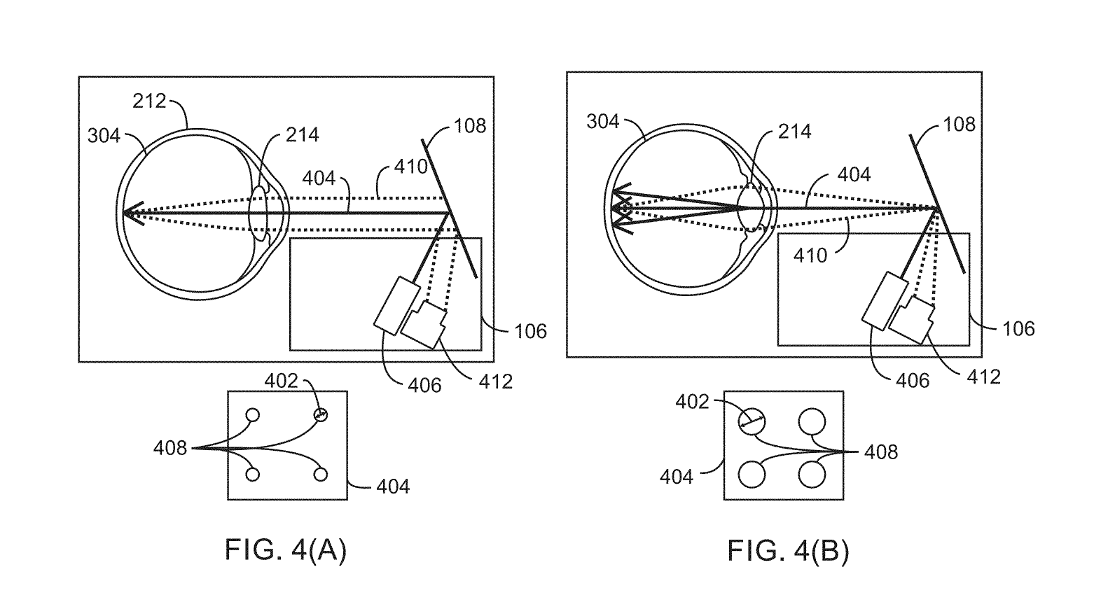

FIGS. 4(A) and 4(B) are schematic diagrams illustrating an example of the determination of a focus plane for an eye 400, using a point spread function 402 of a laser pattern 404 in accordance with some embodiments. Like numbered items are as described with respect to FIGS. 1, 2, and 3. In this example, a laser pattern generator 406 emits the laser pattern 404, which is reflected off the mirror 108 and into the eye 212. As shown the laser pattern 404 may include a series of NIR laser dots 408.

As shown in FIG. 4(A), when the lens 214 of the eye 212 is focused at infinity, the laser pattern 404 may be focused onto the retina 304. The laser pattern 404 may then reflect off the retina 304 and the reflection 410 may then be directed into an imaging device 412 by the mirror 108. At this focus plane, the NIR laser dots 408 may have the lowest point spread function 402, or diameter, indicating the infinite focus.

As shown in FIG. 4(B), if the lens 214 of the eye 212 is focused at a closer distance, the eye 212 will introduce a larger point spread function 402, as indicated by larger diameter of the NIR laser dots 408. The point spread function 402 will increase as the focus distance is reduced.

The imaging device 412 may be used to measure the point spread function 402 as well as performing the eye tracking function. The imaging device 412 may include a higher pixel resolution than would be normally used for the eye tracking function. For example, the imaging device 412 may include an NIR camera with a pixel resolution of about 2 mega pixels (MP), about 5 mega pixels, or higher.

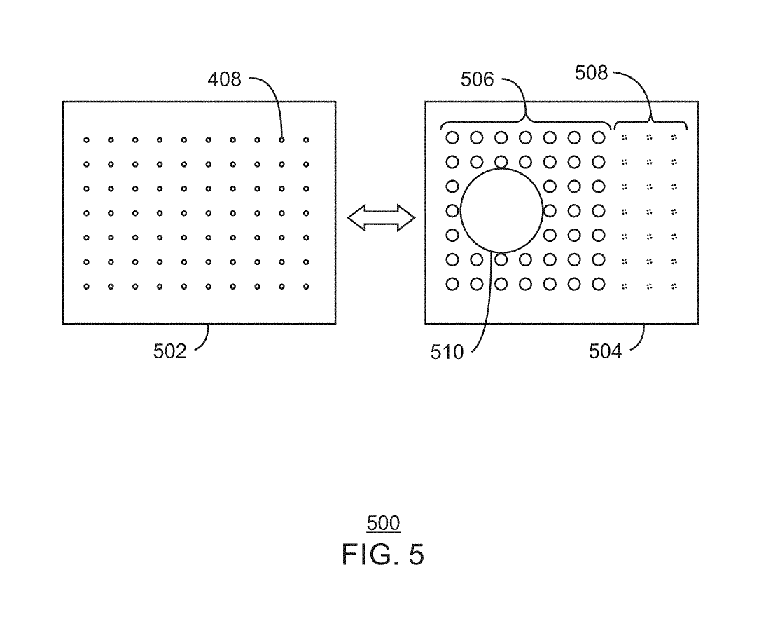

FIG. 5 is a drawing of another example of a laser pattern 500 for the determination of a point spread function to identify a focus plane for a viewer in accordance with some embodiments. As shown in FIG. 5, the number of NIR laser dots 408 in the laser pattern 500 may be increased to increase the probability of an accurate determination of the focus plane, for example, when a user is looking away from the laser pattern generator.

In this example, the emitted pattern 502 includes a 10×7 array of NIR laser dots 408 that may be reflected off the user's eye. The user may be looking off to the side, preventing all of the NIR laser dots 408 from reaching the retina. For example, the detected image 504 may only include a 7×7 array of reflected dots 506. In this example, three columns of dots 508 are not returned due to a user's eye looking away from the laser pattern emitter.

Further, the use of multiple NIR laser dots 408 may be used for eye tracking, or to permit focus plane determination in the presence of a reflection 510 used for eye tracking. This may increase the accuracy of the focus plane determination in the presence of other optical interferences in the detected image 504.

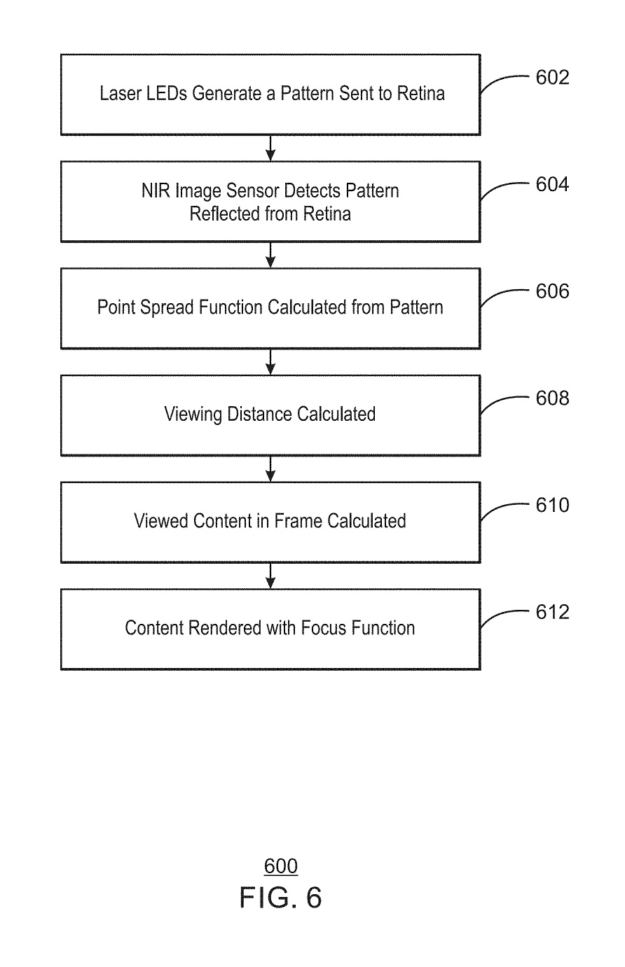

FIG. 6 is a process flow diagram of an example of a method 600 for determining a focus plane of a viewer and rendering objects at the focus plane in focus in accordance with some embodiments. The method may begin at block 602, when laser LEDs are used to generate a pattern that is sent to a retina. At block 604, an NIR image sensor detects the pattern reflected from the retina.

At block 606, a point spread function may be calculated from the pattern reflected from the retina. For example, the point spread function may be determined from the diameter of dots in a detected image. To account for reflections, missing dots, and other optical disturbances, the point spread function may be determined as a largest diameter of dots detected or as an average diameter of dots detected.

At block 608, a viewing distance, or focus plane, may be calculated from the point spread function determined from the pattern reflected from the retina. At block 610, a determination is made of the content that may be visible within the frame. At block 612, the content within the frame may be rendered with the content at the focus plane, or viewing distance, rendered at a highest resolution for the display panel while content not in the focus plane may be rendered at lower resolution, for example, blurry. The rendering resolution may depend on the proximity of the content to the focus plane, wherein as content lands farther from the focus plane it may be rendered at progressively lower resolution.

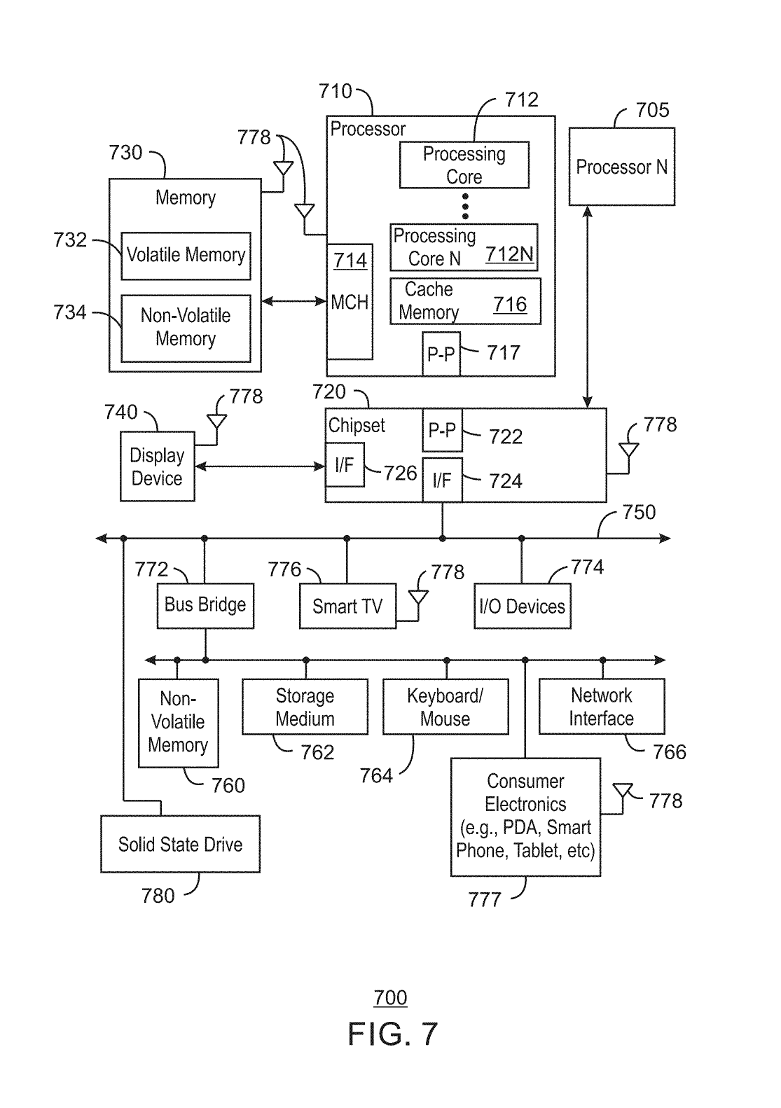

FIG. 7 is a block diagram of an example of a computing system 700 that may be used to provide a head mounted display (HMD) with content in accordance with some embodiments. For example, the HMD described above may be used in conjunction with a processor in system 700 or other part of system 700.

Referring to FIG. 7, system 700 includes, but is not limited to, a desktop computer, a laptop computer, a netbook, a tablet, a notebook computer, a personal digital assistant (PDA), a server, a workstation, a cellular telephone, a mobile computing device, a smart phone, an Internet appliance or any other type of computing device. The system 700 may implement the methods disclosed herein and may be a system on a chip (SOC) system.

The processor 710 may have one or more processor cores 712 to 712N, where 712N represents the Nth processor core inside the processor 710 where N is a positive integer. The system 700 may include multiple processors including processors 710 and 705, where processor 705 has logic similar or identical to logic of processor 710. The system 700 may multiple processors including processors 710 and 705 such that processor 705 has logic that is completely independent from the logic of processor 710. In this example, a multi-package system 700 may be a heterogeneous multi-package system, because the processors 705 and 710 have different logic units. The processing core 712 may include, but is not limited to, pre-fetch logic to fetch instructions, decode logic to decode the instructions, execution logic to execute instructions and the like. The processor 710 may have a cache memory 716 to cache instructions or data of the system 700. The cache memory 716 may include level one, level two and level three, cache memory, or any other configuration of the cache memory within processor 710.

The processor 710 may include a memory control hub (MCH) 714, which is operable to perform functions that enable processor 710 to access and communicate with a memory 730 that includes a volatile memory 732 or a non-volatile memory 734. The memory control hub (MCH) 714 may be positioned outside of processor 710 as an independent integrated circuit.

The processor 710 may be operable to communicate with memory 730 and a chipset 720. In this example, the SSD 780 may execute the computer-executable instructions when the SSD 780 is powered up.

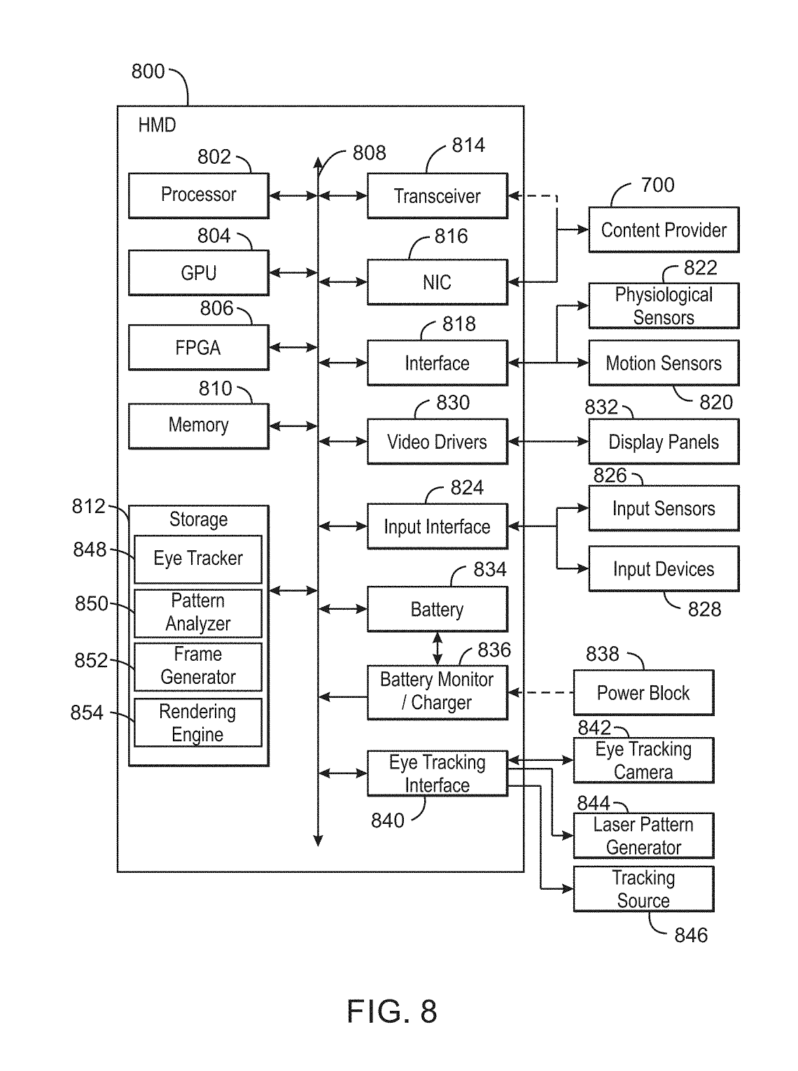

The processor 710 may be also coupled to a wireless antenna 778 to communicate with any device configured to transmit or receive wireless signals. A wireless antenna interface 778 may operate in accordance with, but is not limited to, the IEEE 802.11 standard and its related family, HomePlug AV (HPAV), Ultra Wide Band (UWB), Bluetooth, WiMAX, or any form of wireless communication protocol, for example, as described with respect to FIG. 8.

The volatile memory 732 includes, but is not limited to, Synchronous Dynamic Random Access Memory (SDRAM), Dynamic Random Access Memory (DRAM), RAMBUS Dynamic Random Access Memory (RDRAM), or any other type of random access memory device. The non-volatile memory 734 includes, but is not limited to, flash memory (e.g., NAND, NOR), phase change memory (PCM), read-only memory (ROM), electrically erasable programmable read-only memory (EEPROM), or any other type of non-volatile memory device.

Memory 730 is included to store information and instructions to be executed by processor 710. This may include applications, operating systems, and device drivers, such as software to obtain and provide three-dimensional content to an HMD. The chipset 720 may connect with processor 710 via Point-to-Point (PtP or P-P) interfaces 717 and 722. The chipset 720 may enable processor 710 to connect to other modules in the system 700. The interfaces 717 and 722 may operate in accordance with a PtP communication protocol such as the Intel QuickPath Interconnect (QPI) or the like.

The chipset 720 may be operable to communicate with processor 710, 705, display device 740 (e.g., an HMD display), and other devices 772, 776, 774, 760, 762, 764, 766, 777, etc. The chipset 720 may be coupled to a wireless antenna 778 to communicate with any device configured to transmit or receive wireless signals.

The chipset 720 may connect to a display device 740 via an interface 726. The display device 740 may be an HMD. Other display devices 740 may be used to simultaneously display content being displayed on an HMD. These devices may include, but are not limited to Include, liquid crystal display (LCD), plasma, cathode ray tube (CRT) display, projectors, or any other form of visual display device. In addition, the chipset 720 may connect to one or more buses 750 and 755 that interconnect various modules 774, 760, 762, 764, and 766. The buses 750 and 755 may be interconnected together via a bus bridge 772, for example, if there is a mismatch in bus speed or communication protocol. The chipset 720 couples with, but is not limited to, a non-volatile memory 760, a mass storage device(s) 762, a keyboard/mouse 764, and a network interface 766 via interface 724, smart TV 776, consumer electronics 777, etc. Many of these devices, such as devices 760, 762, 724, 776, and 777, may be used to provide content to an HMD, either as a direct three-dimensional feed, or after processing to generate a simulated three-dimensional feed.

The mass storage device 762 includes, but is not limited to, a solid state drive, a hard disk drive, a universal serial bus flash memory drive, or any other form of computer data storage medium. The network interface 766 may be implemented by any type of well-known network interface standard including, but not limited to, an Ethernet interface, a universal serial bus (USB) interface, a Peripheral Component Interconnect (PCI) Express interface, a wireless interface and/or any other suitable type of interface.

While the modules shown in FIG. 7 are depicted as separate blocks within the system 700, the functions performed by some of these blocks may be integrated within a single semiconductor circuit or may be implemented using two or more separate integrated circuits.

FIG. 8 is a block diagram of an example of components that may be present in an HMD 800 in accordance with some embodiments. Like numbered items are as described with respect to FIG. 7. The IoT device 800 may include any combinations of the components shown in the example. The components may be implemented as ICs, portions thereof, discrete electronic devices, or other modules, logic, hardware, software, firmware, or a combination thereof adapted in the HMD 800, or as components otherwise incorporated within a chassis of a larger system. The block diagram of FIG. 8 is intended to show a high level view of components of the HMD 800. However, some of the components shown may be omitted, additional components may be present, and different arrangement of the components shown may occur in other implementations.

The HMD 800 may include a processor 802, which may be a microprocessor, a multi-core processor, a multithreaded processor, an ultra-low voltage processor, an embedded processor, or other known processing element. The processor 802 may be a part of a system on a chip (SoC) in which the processor 802 and other components are formed into a single integrated circuit, or a single package, such as the Edison™ or Galileo™ SoC boards from Intel. As an example, the processor 802 may include an Intel® Architecture Core™ based processor, such as a Quark™, an Atom™, an i3, an i5, an i7, or an MCU-class processor, or another such processor available from Intel® Corporation, Santa Clara, Calif. However, any number other processors may be used, such as available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or customer thereof, or their licensees or adopters. The processors may include units such as an A5-A9 processor from Apple® Inc., a Snapdragon™ processor from Qualcomm® Technologies, Inc., or an OMAP™ processor from Texas Instruments, Inc.

Other types of processors may be included to accelerate video processing for the three-dimensional display in the HMD 800. These may include, for example, a graphics processing unit (GPU) 804, such as units available from Intel, Nvidia, and ATI, among others. In some examples, the HMD 800 may include a floating-point gate array (FPGA) 806 that is programmed to process video.

A system bus 808 may provide communications between system components. The system bus 808 may include any number of technologies, including industry standard architecture (ISA), extended ISA (EISA), peripheral component interconnect (PCI), peripheral component interconnect extended (PCIx), PCI express (PCIe), or any number of other technologies. The system bus 808 may be a proprietary bus, for example, used in a SoC based system. Further, the system bus 808 may include any combinations of these technologies, as well as other bus systems, such as an I²C interface, I³C interface, an SPI interface, point to point interfaces, and a power bus, among others. Different components may be coupled by different technologies in the system bus 808. For example, the processors 802, 804, and 806 may be linked by high-speed point-to-point interfaces.

The processors 802, 804, or 806 may communicate with each other, or with other components, such as a system memory 810, over the system bus 808. The system memory 810 may include any number of memory devices of different types to provide for a given amount of system memory. As examples, the memory can be random access memory (RAM) in accordance with a Joint Electron Devices Engineering Council (JEDEC) low power double data rate (LPDDR)-based design such as the current LPDDR2 standard according to JEDEC JESD 209-2E (published April 2009), or a next generation LPDDR standard, such as LPDDR3 or LPDDR4 that will offer extensions to LPDDR2 to increase bandwidth. In various implementations the individual memory devices may be of any number of different package types such as single die package (SDP), dual die package (DDP) or quad die package (Q17P). These devices, in some embodiments, may be directly soldered onto a motherboard to provide a lower profile solution for the HMD 800.

Any number of other memory implementations may be used, such as other types of memory modules, e.g., dual inline memory modules (DIMMs) of different varieties including but not limited to microDIMMs or MiniDIMMs. For example, a memory may be sized between 2 GB and 16 GB, and may be configured as a DDR3LM package or an LPDDR2 or LPDDR3 memory, which is soldered onto a motherboard via a ball grid array (BGA).

To provide for persistent storage of information such as data, applications, operating systems and so forth, a mass storage 812 may also be coupled to the processors 802, 804, and 806, via the bus 808. To enable a thinner and lighter design for the HMD 800, the mass storage 812 may be implemented via a solid state drive (SSD). Other devices that may be used for the mass storage 808 include flash memory cards, such as SD cards, microSD cards, xD picture cards, and the like.

In low power implementations, such as an HMD 800 that is powered by battery, the mass storage 812 may be on-die memory or registers associated with the processors 802, 804, and 806. However, in some examples, the mass storage 808 may be implemented using a micro hard disk drive (HDD). Further, any number of new technologies may be used for the mass storage 808 in addition to, or instead of, the technologies described, such resistance change memories, phase change memories, holographic memories, or chemical memories, among others. For example, the HMD 800 may incorporate the 3D XPOINT memories from Intel® and Micron®.

The system bus 808 may couple the processors 802, 804, and 806 to a transceiver 814, for example, for communications with a content provider 700. The transceiver 814 may use any number of frequencies and protocols, such as 2.4 gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the content provider 700. For example, a WLAN unit may be used to implement Wi-Fi™ communications in accordance with the Institute of Electrical and Electronics Engineers (IEEE) 802.11 standard. In addition, wireless wide area communications, e.g., according to a cellular or other wireless wide area protocol, can occur via a WWAN unit. Further, any of the communications devices mentioned with respect to FIG. 7 may be used.

A network interface controller (NIC) 816 may be included to provide a wired communication to the content provider 700. The wired communication may provide an Ethernet connection, or may be based on a proprietary network protocol, for example, designed for carrying high-speed video data. An additional NIC 816 may be included to allow a connection to a second network, for example, a first NIC 816 providing communications to the content provider 700, and a second NIC 816 providing communications to other devices, such as input devices, over another type of network.

The system bus 808 may couple the processors 802, 804, and 806 to an interface 818 that is used to connect other devices. The devices may include motion sensors 820, such as MEMS accelerometers, MEMS gyroscopic sensors, optical motion sensors, and the like. The interface 818 may be used to connect the HMD 800 to physiological sensors 822, such as heart rate sensors, temperature sensors, perspiration detectors, and the like.

The system bus 808 may couple the processors 802, 804, and 806 to an input interface 824. The input interface 824 may couple the HMD 800 to input sensors 826, such as virtual reality (VR) gloves, VR pointers, and other input sensors 826. The input interface 824 may also couple the HMD 802 input devices 828. The input devices 828 may include mice, trackballs, keyboards, and the like.

Video drivers 830 may interface the system bus 808 to the display panels 832 in the HMD 800. As described herein, the display panels 832 may include OLED panels, LCD panels, and the like.

A battery 834 may power the HMD 800, although in examples in which the HMD 800 is coupled to the content provider 700 by a cable, it may have a power supply coupled to an electrical grid. The battery 834 may be a lithium ion battery, a metal-air battery, such as a zinc-air battery, an aluminum-air battery, a lithium-air battery, a hybrid super-capacitor, and the like.

A battery monitor/charger 836 may be included in the HMD 800 to track the state of charge (SoCh) of the battery 834. The battery monitor/charger 836 may be used to monitor other parameters of the battery 834 to provide failure predictions, such as the state of health (SoH) and the state of function (SoF) of the battery 834. The battery monitor/charger 836 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 836 may communicate the information on the battery 834 to the processors 802, 804, and 806 over the bus 808. The battery monitor/charger 836 may also include an analog-to-digital (ADC) convertor that allows the processors 802, 804, and 806 to directly monitor the voltage of the battery 836 or the current flow from the battery 834. The battery parameters may be used to determine actions that the HMD 800 may perform, for example, when battery reserves are low, such as user alerts, transmission frequency changes, network operation, and the like.

A power block 838, or other power supply coupled to a grid, may be coupled with the battery monitor/charger 836 to charge the battery 834. In some examples, the power block 838 may be replaced with a wireless power receiver to obtain the power wirelessly, for example, through a loop antenna in the HMD 800. A wireless battery charging circuit, such as an LTC4020 chip from Linear Technologies of Milpitas, Calif., among others, may be included in the battery monitor/charger 836. The specific charging circuits chosen depend on the size of the battery 834, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

An eye tracking interface 840 may couple the circuitry of the HMD 800 to an eye tracking camera 842. The eye tracking camera 842 may be, for example, a high resolution NIR CCD camera, as described herein. Further, the eye tracking interface 840 may power a laser pattern generator 844, which may include, for example, an array of NIR laser LEDs. The eye tracking interface 840 may also power a tracking light source 846 such as NIR LEDs that may be used to track the orientation of the eyes.

The mass storage 812 may include a number of modules to implement the functions described herein. Although shown as code blocks in the mass storage 812, it may be understood that any of the modules may be fully or partially replaced with hardwired circuits, for example, built into an application specific integrated circuit (ASIC).

The mass storage 812 may include an eye tracker 848 that may track the orientation of the user's eyes using the eye tracking interface 842 to control the eye tracking camera 842 and the light sources 844 and 846. In addition to tracking the orientation of the user's eyes, the eye tracker 848 may analyze the images from the eye tracking camera 842 to identify the laser pattern reflected from the retina of the user's eye. The laser pattern may be provided to a pattern analyzer 850.

The pattern analyzer 850 may determine the point spread function for the laser pattern. This may be performed, as described herein, by determining the increase in diameter of points or dots in the laser pattern as a user changes from an infinite focus to a close focus. The point spread function may be used to determine the focus plane for the user.

A frame generator 852 may determine what content from a scene is within view of a user, for example, based on the orientation of the user's eyes, and head. A rendering engine 854 may then render the content, with content that is at the focus plane for the user rendered at high resolution, or in focus. Content that is not at the focus plane for the user may be rendered at lower resolutions, for example, blurry. The resolution of the content that is not at the focus plane for the user may be rendered at incrementally higher resolutions as it approaches the focus plane for the user.

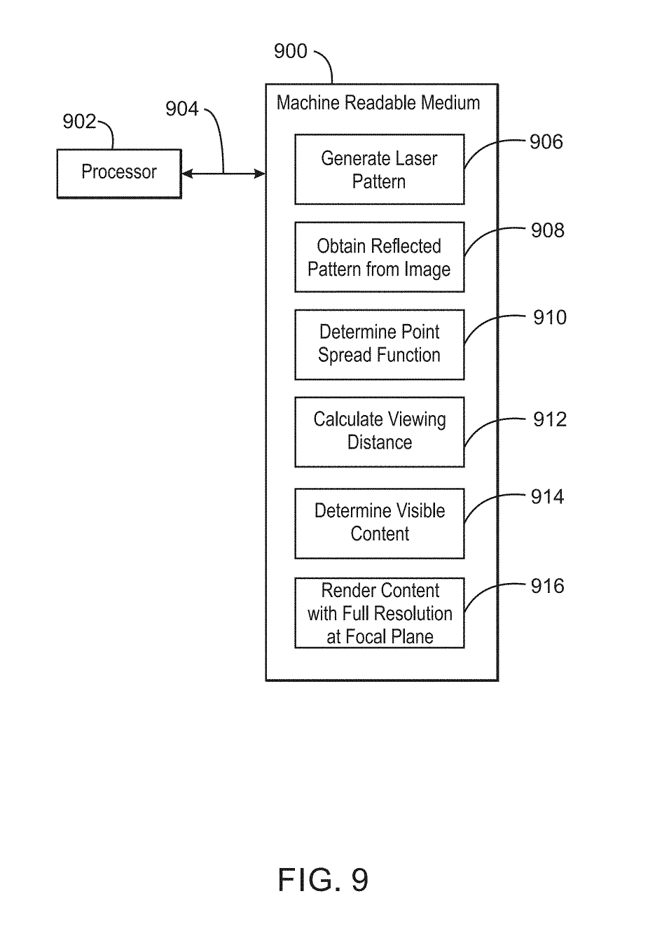

FIG. 9 is a block diagram of a non-transitory, machine readable medium 900 that may include code to direct a processor to determine a focus plane of a viewer and render objects at the focus plane in focus in accordance with some embodiments. The processor 902 may access the non-transitory, machine readable medium 900 over a bus 904. The processor 902 and bus 904 may be selected as described with respect to the processors 802, 804, and 806 and bus 808 of FIG. 8. The non-transitory, machine readable medium 900 may include devices described for the mass storage 808 of FIG. 8 or may include optical disks, thumb drives, or any number of other hardware devices.

The non-transitory, machine readable medium 900 may include code 906 to direct the processor 902 to generate a laser pattern, for example, by activating an array of NIR laser LEDs. Code 908 may be included to direct the processor 902 to obtain a reflected pattern from an image of a user eye, wherein the image is collected from an NIR camera, for example, pointed at a mirror to collect a reflection from the eye.

The machine readable medium 900 may include code 910 to direct the processor 902 to determine a point spread function from the reflected pattern. For example, the code 910 may direct the processor 902 to measure a diameter of a number of laser dots in the reflected image, wherein the diameter is proportional to the point spread function.

The machine readable medium 900 may include code 912 to direct the processor 902 to calculate a focus plane for an eye. The code 912 may then direct to calculate a viewing distance for a user from the focus plane for each of the user's eyes.

The machine readable medium 900 may include code 914 to direct the processor 902 to determine visible content for a user, based, at least in part, on the position of the user's eyes and head. Code 916 may be included to direct the processor 902 to render the content that is visible to the user on display panels in the head mounted display. The code 916 may direct the processor 902 to render the content that is at the viewing distance for the user at full resolution, e.g., in focus, and render content that is not at the viewing distance for the user at lower resolution, e.g., blurry. The resolution used for the rendering may change depending on the difference between the content and the viewing distance. For example, content closer to the viewing distance may be rendered at incrementally higher resolutions while content farther from the viewing distance a be rendered at incrementally lower resolutions.

### EXAMPLES

Example 1 includes a head-mounted display (HMD) device. The HMD device includes a laser pattern generator to generate a pattern that is directed into an eye and reflected off of a retina and back out of the eye. A camera is to capture an image of a reflected pattern from the retina. A pattern analyzer is to determine a point spread function for the eye from the reflected pattern and to determine a focus plane for a user from the point spread function. A rendering engine is to render content on a display, wherein content at the focus plane is rendered in focus and content not at the focus plane is rendered blurry.

Example 2 includes the subject matter of either of example 1. In this example, the rendering engine is to render content at the focus plane at a higher resolution of the display, and render content not at the focus plane at a lower resolution for the display.

Example 3 includes the subject matter of either of examples 1 or 2. In this example, a higher resolution includes the highest resolution available for the display.

Example 4 includes the subject matter of any of examples 1 to 3. In this example, a lower resolution is determined by a distance between the content and the focus plane.

Example 5 includes the subject matter of any of examples 1 to 4. In this example, the rendering engine to apply a blur function to the content, wherein a strength of the blur function is based on a distance between a visible object and the focus plane.

Example 6 includes the subject matter of any of examples 1 to 5. In this example, the HMD device includes a mirror designed to reflect near infra-red light while transmitting visible light to reflect the pattern into the eye.

Example 7 includes the subject matter of any of examples 1 to 6. In this example, the laser pattern generator includes vertical cavity surface emitting lasers (VCSELs).

Example 8 includes the subject matter of any of examples 1 to 7. In this example, the laser pattern generator includes a near infrared laser light emitting diodes (NIR laser LEDs).

Example 9 includes the subject matter of any of examples 1 to 8. In this example, the pattern includes a matrix of dots.

Example 10 includes the subject matter of any of examples 1 to 9. In this example, a point spread function includes a diameter of dots reflected off of a retina.

Example 11 includes the subject matter of any of examples 1 to 10. In this example, the camera includes a CMOS image sensor that detects light in near infrared (NIR) wavelengths.

Example 12 includes the subject matter of any of examples 1 to 11. In this example, the camera has greater than about two mega pixel resolution.

Example 13 includes the subject matter of any of examples 1 to 12. In this example, the HMD device includes near infrared light (NIR) emitting diodes positioned to reflect NIR light off an external surface of an eye.

Example 14 includes the subject matter of any of examples 1 to 13. In this example, an external reflection of NIR light is detected by the camera to track an orientation of an eye.

Example 15 includes the subject matter of any of examples 1 to 14. In this example, the HMD device includes a motion sensor to determine an orientation of a user's head.

Example 16 includes the subject matter of any of examples 1 to 15. In this example, the HMD device includes a frame generator to determine the content that is visible to a user, based, at least in part, on the orientation of the user's head and eyes.

Example 17 includes the subject matter of any of examples 1 to 16. In this example, the display includes a liquid crystal device (LCD) display panel.

Example 18 includes the subject matter of any of examples 1 to 17. In this example, the display includes an organic light emitting diode (OLED) display panel.

Example 19 includes a method for focusing content in a head-mounted display (HMD) device. The method includes generating a near infrared (NIR) pattern using a laser source, and detecting a reflection of the pattern from a retina of an eye. A point spread function is calculated from the reflection, and a viewing distance is calculated from the point spread function. Visible content for a user is determined and the visible content is rendered, wherein content at the viewing distance is rendered in focus on the display panel.

Example 20 includes the subject matter of example 19. In this example, the method includes reflecting the pattern into an eye.

Example 21 includes the subject matter of either of examples 19 or 20. In this example, the method includes emitting the pattern into the eye.

Example 22 includes the subject matter of any of examples 19 to 21. In this example, generating the NIR pattern includes generating an array of dots from a number of vertical cavity surface emitting lasers (VCSELs).

Example 23 includes the subject matter of any of examples 19 to 22. In this example, detecting the reflection of the pattern includes capturing an image of the pattern on an imaging device.

Example 24 includes the subject matter of any of examples 19 to 23. In this example, calculating the point spread function includes determining a diameter of a dot in the reflection.

Example 25 includes the subject matter of any of examples 19 to 24. In this example, determining visible content for the user includes determining an orientation of a user's head.

Example 26 includes the subject matter of any of examples 19 to 25. In this example, the method includes rendering content that is not at the viewing distance at a lower resolution on the display panel.

Example 27 includes the subject matter of any of examples 19 to 26. In this example, the method includes rendering content that is not at the viewing distance at a resolution based, at least in part, on a difference between the distance of the content and the viewing distance.

Example 28 includes a non-transitory, machine readable medium including code that, when executed, directs a processor to generate a laser pattern and obtain a reflection of the laser pattern from an image collected of an eye. Code is included that, when executed, directs the processor to determine a point spread function of the laser pattern from the reflection and calculate a viewing distance based on the point spread function.

Example 29 includes the subject matter of example 28. In this example, the non-transitory, machine readable medium includes code that, when executed, directs the processor to obtain an orientation for a user's head and determine visible content based on the orientation.

Example 30 includes the subject matter of either of examples 28 or 29. In this example, the non-transitory, machine readable medium includes code that, when executed, directs the processor to render content at the viewing distance at a higher resolution on a display.

Example 31 includes a non-transitory, machine-readable medium including instructions to direct a processor in a node to perform any one of the methods of examples 19 to 27.

Example 32 includes an apparatus, including means to perform any one of the methods of examples 19 to 27.

Example 33 includes a head-mounted display (HMD) device. The HMD device includes a laser pattern generator to generate a pattern that is directed into an eye and reflected off of a retina and back out of the eye. A camera is included to capture an image of a reflected pattern from the retina. The HMD device includes a means for determining a point spread function for the eye from the reflected pattern and determining a focus plane for user from the point spread function. A rendering engine is included to render content on the display, wherein content at the focus plane is rendered in focus and content not at the focus plane is rendered blurry.

Example 34 includes the subject matter of any of examples 33 to 34. In this example, the HMD device includes a means for reflecting near infra-red light while transmitting visible light to reflect the pattern into the eye.

Example 35 includes the subject matter of any of examples 33 to 35. In this example, the HMD device includes a means to detect light in near infrared (NIR) wavelengths.

Example 36 includes the subject matter of any of examples 33 to 36. In this example, the HMD device includes a means to track an orientation of an eye.

Example 37 includes the subject matter of any of examples 33 to 37. In this example, the HMD device includes a means to determine an orientation of a user's head.

Example 38 includes the subject matter of any of examples 33 to 37. In this example, the HMD device includes a means to determine the content that is visible to a user.

In the preceding description, various aspects of the disclosed subject matter have been described. For purposes of explanation, specific numbers, systems and configurations were set forth in order to provide a thorough understanding of the subject matter. However, it is apparent to one skilled in the art having the benefit of this disclosure that the subject matter may be practiced without the specific details. In other instances, well-known features, components, or modules were omitted, simplified, combined, or split in order not to obscure the disclosed subject matter.

Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

Program code may represent hardware using a hardware description language or another functional description language which essentially provides a model of how designed hardware is expected to perform. Program code may be assembly or machine language or hardware-definition languages, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Program code may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any tangible mechanism for storing, transmitting, or receiving information in a form readable by a machine, such as antennas, optical fibers, communication interfaces, etc. Program code may be transmitted in the form of packets, serial data, parallel data, etc., and may be used in a compressed or encrypted format.

Program code may be implemented in programs executing on programmable machines such as mobile or stationary computers, personal digital assistants, set top boxes, cellular telephones and pagers, and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, graphics processing units, minicomputers, mainframe computers, as well as pervasive or miniature computers or processors that may be embedded into virtually any device. Embodiments of the disclosed subject matter can also be practiced in distributed computing environments where tasks may be performed by remote processing devices that are linked through a communications network.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

Some embodiments may be implemented in one or a combination of hardware, firmware, and software. Some embodiments may also be implemented as instructions stored on the tangible, non-transitory, machine-readable medium, which may be read and executed by a computing platform to perform the operations described. In addition, a machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more embodiments. For instance, all optional features of the computing device described above may also be implemented with respect to either of the method or the computer-readable medium described herein. Furthermore, although flow diagrams and/or state diagrams may have been used herein to describe embodiments, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. A head-mounted display (HMD) device, comprising:
a laser pattern generator to generate a pattern that is directed into an eye and reflected off of a retina and back out of the eye;
a camera to capture an image of a reflected pattern from the retina;
a pattern analyzer to determine a point spread function for the eye from the reflected pattern and to determine a focus plane for a user from the point spread function; and
a rendering engine to render content on a display, wherein content at the focus plane is rendered in focus and content not at the focus plane is rendered blurry.

2. The HMD device of claim 1, the rendering engine to render content at the focus plane at a higher resolution of the display, and to render content not at the focus plane at a lower resolution for the display, wherein the lower resolution is determined by a distance between the content and the focus plane.

3. The HMD device of claim 1, the rendering engine to apply a blur function to the content, wherein a strength of the blur function is based on a distance between a visible object and the focus plane.

4. The HMD device of claim 1, comprising a mirror designed to reflect near infra-red light while transmitting visible light to reflect the pattern into the eye.

5. The HMD device of claim 1, wherein the laser pattern generator comprises vertical cavity surface emitting lasers (VCSELs).

6. The HMD device of claim 1, wherein the pattern comprises a matrix of dots.

7. The HMD device of claim 6, wherein the point spread function comprises a diameter of reflected dots from the retina.

8. The HMD device of claim 1, wherein the camera comprises a CMOS image sensor that detects light in near infrared (NIR) wavelengths.

9. The HMD device of claim 1, wherein the camera has greater than about two mega pixel resolution.

10. The HMD device of claim 1, comprising near infrared light (NIR) emitting diodes position to reflect NIR light off an external surface of an eye.

11. The HMD device of claim 10, wherein an external reflection of NIR light is detected by the camera to track an orientation of an eye.

12. The HMD device of claim 1, comprising a motion sensor to determine an orientation of a user's head.

13. The HMD device of claim 12, comprising a frame generator to determine the content that is visible to a user, based, at least in part, on the orientation of the user's head and eyes.

14. The HMD device of claim 1, wherein the display comprises a liquid crystal device (LCD) display panel.

15. The HMD device of claim 1, wherein the display comprises an organic light emitting diode (OLED) display panel.

16. A method for focusing content in a head-mounted display (HMD) device, comprising:
generating a near infrared (NIR) pattern using a laser source;
detecting a reflection of the pattern from a retina of an eye;
calculating a point spread function from the reflection;
calculating a viewing distance from the point spread function;
determining visible content for a user; and
rendering the visible content, wherein content at the viewing distance is rendered in focus on a display panel.

17. The method of claim 16, comprising reflecting the pattern into an eye.

18. The method of claim 16, wherein generating the NIR pattern comprises generating an array of dots from a plurality of vertical cavity surface emitting lasers (VCSELs).

19. The method of claim 16, wherein detecting the reflection of the pattern comprises capturing an image of the pattern on an imaging device.

20. The method of claim 16, wherein calculating the point spread function comprises determining a diameter of a dot in the reflection.

21. The method of claim 16, wherein determining visible content for the user comprises determining an orientation of a user's head.

22. The method of claim 16, comprising rendering content that is not at the viewing distance at a resolution based, at least in part, on a difference between the distance of the content and the viewing distance.

23. A non-transitory, machine readable medium comprising code that, when executed, directs a processor to:
generate a laser pattern;
obtain a reflection of the laser pattern from an image collected of an eye;
determine a point spread function of the laser pattern from the reflection; and
calculate a viewing distance based on the point spread function.

24. The non-transitory, machine readable medium of claim 23, comprising code that, when executed, directs the processor to:
obtain an orientation for a user's head; and
determine visible content based on the orientation.

25. The non-transitory, machine readable medium of claim 23, comprising code that, when executed, directs the processor to render content at the viewing distance at a higher resolution on a display.
